(19) United States
(12) Patent Application Publication
(10) Pub. No.: US 2025/0199221 A1
(43) Pub. Date: Jun. 19, 2025

(54) VARIABLE WAVELENGTH INTERFERENCE FILTER

(71) Applicant: SEIKO EPSON CORPORATION, TOKYO (JP)

(72) Inventors: Mitsumi KISHIDA, SHIOJIRI-SHI (JP); Kei KUDO, Shiojiri-shi (JP)

(21) Appl. No.: 18/985,125

(22) Filed: Dec. 18, 2024

(30) Foreign Application Priority Data
Dec. 18, 2023 (JP) 2023-212754

(51) Int. Cl. G02B 5/28; G02B 5/00; G02B 5/20

(52) U.S. Cl. CPC G02B 5/286; G02B 5/005; G02B 5/207

(57) ABSTRACT

A variable wavelength interference filter includes: a first substrate provided with a first reflective film; and a second substrate provided with a second reflective film that is opposed to the first reflective film with a gap being interposed between the first reflective film and the second reflective film, in which the first substrate includes an SOI substrate in which a first layer, a second layer, and a third layer are layered in this order along a thickness direction, the first substrate includes: a movable unit provided with the first reflective film; a diaphragm unit configured to surround the movable unit; and a base section configured to support the movable unit through the diaphragm unit so as to be able to advance and retreat along the thickness direction, the diaphragm unit is a portion having a thickness in the thickness direction smaller than the base section due to a groove opening in a surface of the first substrate that is at an opposite side from the second substrate, and includes the second layer and the third layer, and at least surfaces, at the second substrate side, of the base section and the diaphragm unit of the first substrate are flat when the movable unit is not displaced.

The present application is based on, and claims priority from JP Application Serial Number 2023-212754, filed on Dec. 18, 2023, the disclosure of which is hereby incorporated by reference herein in its entirety.

### BACKGROUND

### 1. Technical Field

The present disclosure relates to a variable wavelength interference filter.

### 2. Related Art

A variable wavelength interference filter is known (for example, JP-A-2021-001965). The variable wavelength interference filter outputs light having a predetermined wavelength from incident light. The variable wavelength interference filter described in JP-A-2021-001965 includes: a first substrate provided with a first mirror; a second substrate provided with a second mirror that is opposed to the first mirror with a gap being interposed between them; a first electrode included in the first substrate; and a second electrode included in the second substrate. A movable unit and a diaphragm unit are formed by forming a resist pattern in which a position corresponding to the diaphragm unit of the first substrate is opened, and performing wet etching (isotropic etching). Thus, the diaphragm unit has a shape including a flat section corresponding to a masked position and also including a first sloped section and a second sloped section disposed around the flat section and formed through over-etching.

In a case of JP-A-2021-001965 described above, the first sloped section is formed through wet etching along the outer periphery of the ring-shaped flat section of the diaphragm unit, and the second sloped section is formed along the inner periphery. Thus, the first sloped section and the second sloped section are provided in the variable wavelength interference filter, and the size of the movable unit decreases by the amount corresponding to the first sloped section and the second sloped section, which is a problem. In addition, in a case of the wet etching, it is difficult to adjust the amount of etching, and also difficult to control the film thickness such that the flat section has a constant thickness. This leads to a problem of a deterioration in the yield and an increase in processing load.

### SUMMARY

A variable wavelength interference filter according to a first aspect of the present disclosure includes a first substrate provided with a first reflective film, and a second substrate provided with a second reflective film that is opposed to the first reflective film with a gap being interposed between the first reflective film and the second reflective film, in which the first substrate includes an SOI substrate in which a first layer, a second layer, and a third layer are layered in this order along a thickness direction from the first substrate toward the second substrate, the first substrate including Si, the second layer including SiO₂, the third layer including Si, the first substrate includes a movable unit provided with the first reflective film, a diaphragm unit configured to surround the movable unit as viewed from the thickness direction from the first substrate toward the second substrate, and a base section configured to surround the diaphragm unit as viewed from the thickness direction and support the movable unit through the diaphragm unit so as to be able to advance and retreat along the thickness direction, the diaphragm unit is a portion having a thickness in the thickness direction smaller than the base section due to a groove opening in a surface of the first substrate that is at an opposite side from the second substrate, and includes the second layer and the third layer, and at least surfaces, at a side of the second substrate, of the base section and the diaphragm unit of the first substrate are flat when the movable unit is not displaced.

### BRIEF DESCRIPTION OF THE DRAWINGS

FIG. 1 is a perspective view illustrating the schematic configuration of a variable wavelength interference filter according to a first embodiment.

FIG. 2 is a perspective view illustrating the schematic configuration of a first substrate that constitutes the variable wavelength interference filter according to the first embodiment.

FIG. 3 is a perspective view illustrating the schematic configuration of a second substrate that constitutes the variable wavelength interference filter according to the first embodiment.

FIG. 4 is a cross-sectional view illustrating the schematic configuration of the variable wavelength interference filter according to the first embodiment.

FIG. 5 is a diagram illustrating the optical spectrum concerning the variable wavelength interference filter according to the first embodiment and the optical spectrum concerning a variable wavelength interference filter according to a comparative example.

FIG. 6 is a diagram illustrating a process of manufacturing a special SOI substrate.

FIG. 7 is a schematic plan view illustrating a portion of a SOI substrate serving as a base member of the first substrate.

FIG. 8 is a diagram illustrating a method of manufacturing the variable wavelength interference filter according to the first embodiment.

FIG. 9 is a cross-sectional view illustrating the schematic configuration of a variable wavelength interference filter according to a second embodiment.

FIG. 10 is a diagram illustrating a method of manufacturing the variable wavelength interference filter according to the second embodiment.

FIG. 11 is a schematic plan view illustrating a first substrate (special SOI substrate serving as a base member) before a diaphragm unit according to a second modification example is formed.

### DESCRIPTION OF EMBODIMENTS

### First Embodiment

Below, a variable wavelength interference filter according to the first embodiment will be described.

### Entire Configuration of Variable Wavelength Interference Filter 1

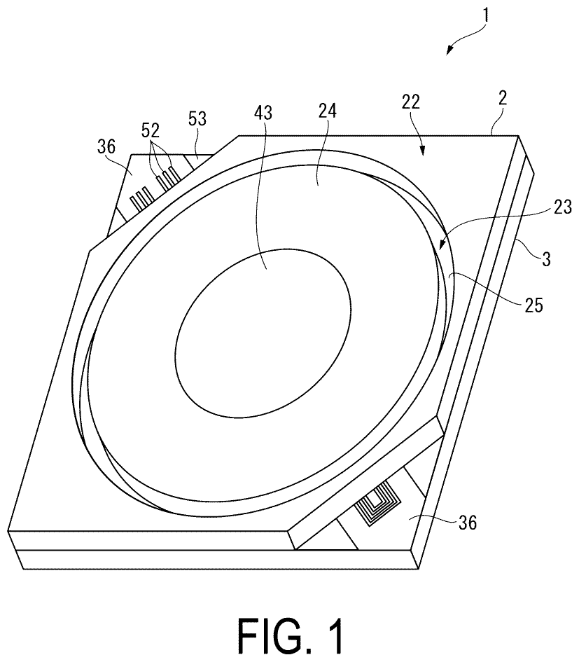

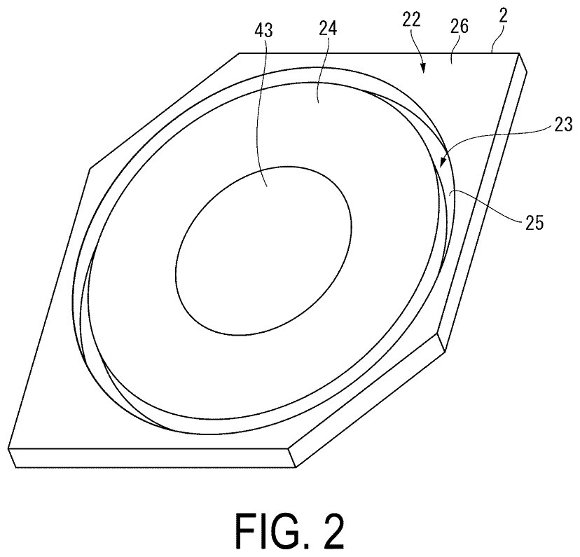

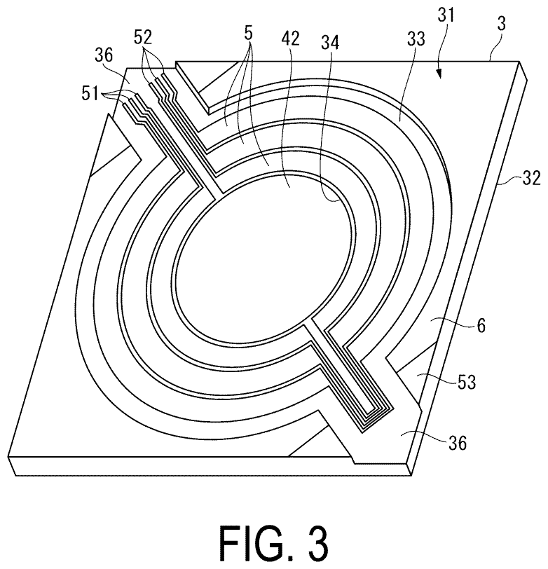

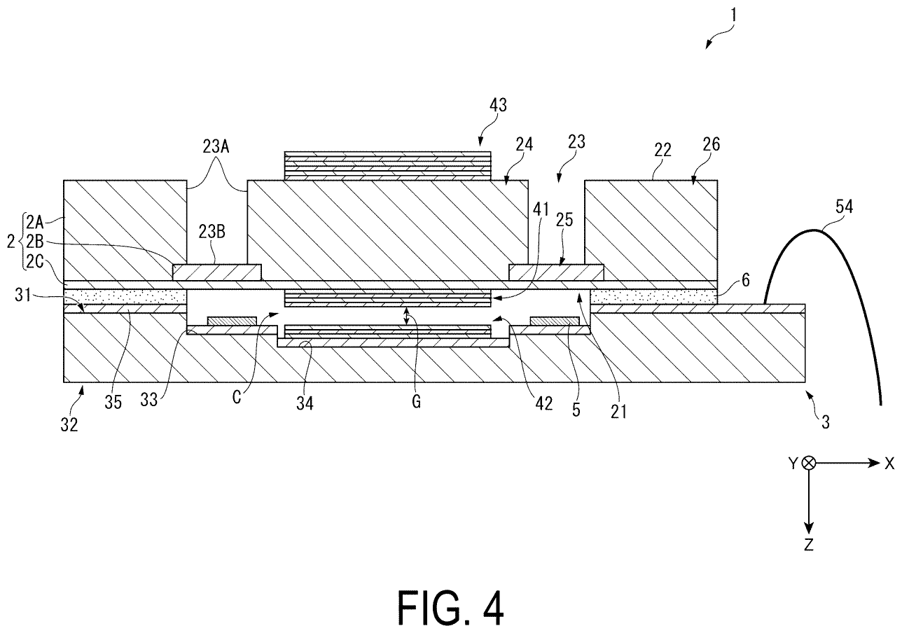

FIG. 1 is a perspective view illustrating the schematic configuration of a variable wavelength interference filter 1 according to the first embodiment. FIG. 2 is a perspective view illustrating the schematic configuration of a first substrate that constitutes the variable wavelength interference filter 1. FIG. 3 is a perspective view illustrating the schematic configuration of a second substrate that constitutes the variable wavelength interference filter 1. FIG. 4 is a cross-sectional view illustrating the schematic configuration of the variable wavelength interference filter 1. This variable wavelength interference filter 1 is a spectral filter that is able to change the transmitting wavelength in accordance with a drive voltage inputted from the outside.

The variable wavelength interference filter 1 according to the present embodiment includes a first substrate 2 and a second substrate 3 disposed so as to be opposed to each other, and also includes a first reflective film 41 (see FIG. 4) provided at the first substrate 2, a second reflective film 42 (see FIGS. 3 and 4) provided at the second substrate 3, and a drive electrode 5 (see FIGS. 3 and 4) provided at the second substrate, as illustrated in FIGS. 1 and 4.

Note that, in the following description, the Z direction represents a direction from the first substrate 2 toward the second substrate 3, the X direction represents one direction perpendicular to the Z direction, and the Y direction represents a direction perpendicular to the Z direction and the X direction. The Z direction corresponds to a thickness direction of the variable wavelength interference filter 1.

The first substrate 2 and the second substrate 3 are each made of a material that can transmits light. In the present embodiment, the first substrate 2 is a substrate formed by processing the shape of a silicon on insulator (SOI) substrate on an as-necessary basis. The second substrate 3 is a substrate formed by processing the shape of an Si substrate on an as-necessary basis.

Specifically, the first substrate 2 is configured by processing, on an as-necessary basis, an SOI substrate in which a supporting layer 2A including Si, a buried oxide (BOX) layer 2B including SiO., and an active layer 2C including Si are layered in this order along the Z direction. Note that the supporting layer 2A serves as a first layer in the present disclosure. The BOX layer 2B serves as a second layer in the present disclosure. The active layer 2C serves as a third layer in the present disclosure.

In addition, the first substrate 2 according to the present embodiment is formed of a special SOI substrate. In other words, the first substrate 2 is an SOI substrate in which the BOX layer 2B is disposed only at a predetermined location, and the other portions are comprised of the supporting layer 2A and the active layer 2C.

In the present embodiment, the first substrate 2 includes a first surface 21 that is opposed to the second substrate 3, and also includes a second surface 22 that is a surface disposed at an opposite side from the first surface 21. An annular groove 23 configured to surround the first reflective film 41 is formed at the second surface 22 of the first substrate 2, when the first substrate 2 is viewed from the Z direction. Thus, the first substrate 2 includes a movable unit 24 where the first reflective film 41 is provided, a diaphragm unit 25 configured to surround the movable unit 24, and a base section 26 configured to support the movable unit 24 through the diaphragm unit 25 so as to be able to be displaced in the Z direction.

Here, the position where the BOX layer 2B described above is provided is disposed in a predetermined margin region with the diaphragm unit 25 being the center. In other words, the BOX layer 2B is disposed at the diaphragm unit 25, at a region of the movable unit 24 that extends up to the inner side of a predetermined margin from the boundary position relative to the diaphragm unit 25, and at a region of the base section 26 that extends up to the outer side of the predetermined margin from the boundary position relative to the diaphragm unit 25. Thus, in most of the center portion of the movable unit 24 and most of the base section 26, the active layer 2C is stacked on the supporting layer 2A, that is, are made only of Si.

The diaphragm unit 25 is a portion in which the groove 23 penetrates through the supporting layer 2A and the front surface of the BOX layer 2B is exposed. In addition, the diaphragm unit 25 is formed so as to have a thickness in the Z direction smaller than the movable unit 24 and the base section 26. In other words, the diaphragm unit 25 is comprised of the BOX layer 2B and the active layer 2C.

More specifically, the groove 23 formed in the first substrate 2 is opened in the second surface 22 that is the front surface of the first substrate 2, and at the same time, the groove 23 annularly extends so as to surround the movable unit 24, as illustrated in FIG. 4. Here, the width direction (hereinafter, referred to as a groove width direction) of the groove 23 is a direction perpendicular to the Z direction as well as a direction (in the circumferential direction) in which the groove 23 extends, and is determined for each location in the direction in which the groove 23 extends. This groove 23 is opened in the second surface 22 of the first substrate 2. In addition, the groove 23 includes a side wall 23A along the Z direction, and is configured such that the front surface of the BOX layer 2B constitutes the bottom surface 23B. In other words, the side wall 23A of the groove 23 is perpendicular or substantially perpendicular to the bottom surface 23B. Thus, the groove 23 is configured such that a width W1 in the groove width direction is uniform from the opening end at the second surface 22 side to the bottom surface 23B of the BOX layer 2B.

In addition, in the present embodiment, the diaphragm unit 25 is configured so as to have a double-layered structure including the BOX layer 2B and the active layer 2C. Thus, in the variable wavelength interference filter 1 according to the present embodiment, the surface of the first substrate 2 that is opposed to the second substrate 3 is comprised of the active layer 2C including the SOI substrate, and is flat when the movable unit 24 is not displaced in the Z direction.

In addition, in the first substrate 2 according to the present embodiment, the active layer 2C is doped with impurities. Specifically, B (boron) or P (phosphorus) is doped as impurities. This makes it possible to improve the electrical conductivity of the active layer 2C, and enables the active layer 2C of the first substrate 2 to function as an electrode.

The second substrate 3 is a substrate formed by processing an Si substrate. The first substrate 2 and the second substrate 3 are integrally configured as a structured body with a cavity C being formed between them.

The second substrate 3 includes a third surface 31 that is opposed to the first substrate 2, and also includes a fourth surface 32 that is a surface disposed at an opposite side from the third surface 31. A first recessed portion 33 having a predetermined depth is formed at a central portion of the third surface 31 of the second substrate 3. With this first recessed portion 33, the cavity C is formed between the first substrate 2 and the second substrate 3. In addition, a reflective-film installation section 34 is formed in the first recessed portion 33. For example, in the present embodiment, the reflective-film installation section 34 is a recessed groove section having a predetermined depth and provided at the bottom surface of the first recessed portion 33.

Note that the reflective-film installation section 34 is set in accordance with the wavelength of light transmitted from the variable wavelength interference filter 1 when the gap between the first reflective film 41 and the second reflective film 42 is the initial gap, that is, in a state where the movable unit 24 is not displaced in the Z direction. Thus, it is only necessary to set the depth of the recessed groove section as the reflective-film installation section 34 on the basis of the initial gap on an as-necessary basis. For example, when the initial gap is reduced, the depth of the recessed groove section is reduced. In some cases, it may be possible to set the reflective-film installation section 34 so as to be the same surface as the bottom surface of the first recessed portion 33. Furthermore, when the initial gap is further reduced, it may be possible to configure the reflective-film installation section 34 as a base that protrudes toward the first substrate 2 side from the bottom surface of the first recessed portion 33.

In the present embodiment, an insulating layer 35 is stacked on the third surface 31 of the second substrate 3, that is, on each of the first recessed portion 33 and the reflective-film installation section 34 that are opposed to the first substrate 2.

The first reflective film 41 is provided at the movable unit 24 of the first substrate 2. The second reflective film 42 is provided at the reflective-film installation section 34 of the second substrate 3. The first reflective film 41 and the second reflective film 42 are opposed to each other with the gap G being interposed between them. The size of this gap G corresponds to the wavelength of light transmitted by the variable wavelength interference filter 1. Note that, when the variable wavelength interference filter 1 is viewed from the Z direction, a region where the first reflective film 41 and the second reflective film 42 are opposed to each other is a filter region of the variable wavelength interference filter 1.

In the present embodiment, a SOI substrate is used for the first substrate 2, and an Si substrate is used for the second substrate 3 to cause light having a desired wavelength to be transmitted with the target being light in a range of near-infrared to infrared. Thus, a film material having a reflective property against the light having the target wavelength region is used as the first reflective film 41 and the second reflective film 42. Specifically, a dielectric multilayer film configured by alternately stacking Si and SiO is used as the first reflective film 41 and the second reflective film 42.

Incidentally, in the present embodiment, the first substrate 2 is manufactured by processing the special SOI substrate. Thus, no BOX layer 2B is provided at a position where the first reflective film 41 of the movable unit 24 is provided. For this reason, in the present embodiment, there is no boundary between the BOX layer 2B and the supporting layer 2A. In addition, there is no boundary between the BOX layer 2B and the active layer 2C. Thus, light is not reflected by these boundaries.

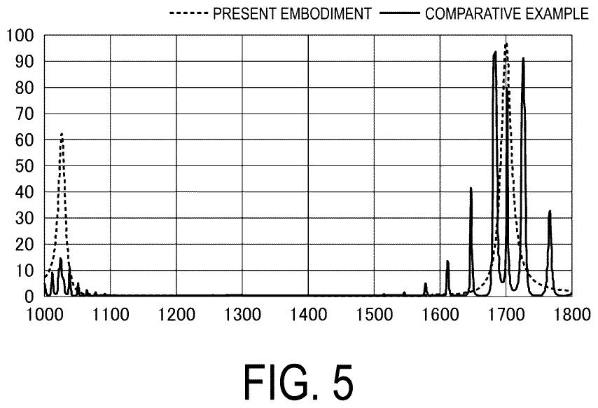

FIG. 5 is a diagram illustrating the optical spectrum (transmission spectrum) concerning the variable wavelength interference filter 1 according to the present embodiment and the optical spectrum (transmission spectrum) concerning a variable wavelength interference filter according to a comparative example. Here, the variable wavelength interference filter according to the comparative example is configured such that, in the variable wavelength interference filter 1 according to the present embodiment, the first substrate 2 is formed of a normal SOI substrate (a substrate in which the BOX layer 2B is provided over the movable unit 24, the diaphragm unit 25, and the base section 26). In FIG. 5, the dashed line indicates the optical wavelength spectrum concerning the variable wavelength interference filter 1 according to the present embodiment, and the solid line indicates the optical spectrum concerning the variable wavelength interference filter according to the comparative example.

The example in FIG. 5 shows the optical spectrum in a case where, in the present embodiment and the comparative example, the size of the gap G is controlled such that the primary peak transmitting wavelength is 1700 nm.

In the comparative example, the boundary between the BOX layer 2B of the SOI substrate and the supporting layer 2A and the boundary between the BOX layer 2B and the active layer 2C exist in the filter region, and hence, light reflects at these boundaries, as illustrated in FIG. 5. In this case, multiple reflection of light occurs between the BOX layer 2B and the first reflective film 41. In a case of the variable wavelength interference filter according to the comparative example, a plurality of peak wavelengths exist at or around the primary peak transmitting wavelength due to such multiple reflection, in addition to the primary peak transmitting wavelength (1700 nm in the example of FIG. 5) that is originally intended to be transmitted.

In contrast, by using the special SOI substrate in which the BOX layer 2B is not provided in the filter region as in the present embodiment, it is possible to suppress such unnecessary multiple reflection. This makes it possible to obtain the optical spectrum having a waveform including one peak with the primary peak transmitting wavelength being the center.

As described above, in the present embodiment, the active layer 2C of the first substrate 2 is doped with impurities to be imparted with electrical conductivity, and functions as an electrode.

In addition, the second substrate 3 is provided with the drive electrode 5 at the bottom 331 of the first recessed portion 33 so as to be opposed to the diaphragm unit 25 with the insulating layer 35 being interposed between them. In other words, the drive electrode 5 is formed in an annular shape or substantially an annular shape so as to surround the second reflective film 42. In addition, this drive electrode 5 may have a multiplexing electrode structure in which a plurality of drive electrodes 5 having different diameter dimensions are provided at the second reflective film 42, as illustrated in FIG. 3. In this case, by controlling a drive voltage applied to the plurality of drive electrodes 5 having different diameter dimensions, it is possible to more precisely control the displacement of the movable unit 24 in the Z direction. Note that FIG. 4 illustrates the configuration in which only one drive electrode 5 is provided, for the purpose of simplification.

Furthermore, as illustrated in FIG. 3, the drive electrode 5 is electrically coupled to a drive electrode terminal 52 disposed outside of the cavity C, with a draw-out wiring line 51 formed at the second substrate 3 being interposed between them.

In addition, by cutting out a portion of the first substrate 2 relative to the second substrate 3 as illustrated in FIG. 2, it is possible to expose a portion (terminal section 36) of the second substrate 3 to the outside as illustrated in FIG. 1. By providing the drive electrode terminal 52 at this terminal section 36, it is possible to easily perform wiring to the drive electrode 5.

Furthermore, when a metal bonding material having electrical conductivity is used as a bonding layer 6 configured to bond the first substrate 2 and the second substrate 3 together, it is preferable to expose a portion of this bonding layer 6 to the terminal section 36. In this case, the bonding layer 6 exposed from the terminal section 36 functions as a common electrode terminal 53, which makes it possible to easily perform wiring to the active layer 2C through the common electrode terminal 53.

Wiring to the drive electrode 5 or the active layer 2C may be performed so as to couple a lead wire 54 to the drive electrode terminal 52 or the common electrode terminal 53 as illustrated, for example, in FIG. 4, or coupling may be performed through a flexible printed circuits (FPC).

With the variable wavelength interference filter 1 having the configuration described above, the common electrode terminal 53 is coupled to the ground, and a drive voltage is inputted into the drive electrode terminal 52, whereby electrostatic attraction acts between the active layer 2C and the drive electrode 5. Thus, the movable unit 24 is displaced toward the second substrate 3 in the Z direction to change the gap G. That is, in the present embodiment, the active layer 2C of the first substrate 2 and the drive electrode 5 function as an actuator for changing the gap G.

### Method of Manufacturing Variable Wavelength Interference Filter 1

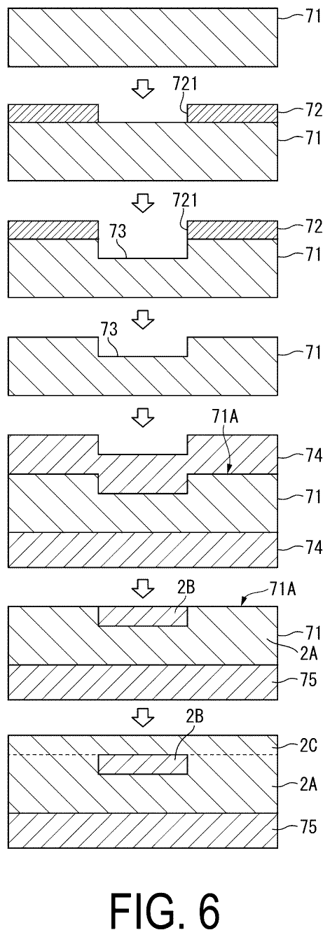

Next, an example of a method of manufacturing the variable wavelength interference filter 1 according to the present embodiment will be described with reference to FIG. 6. First, description will be made of manufacturing of a base member of the first substrate 2 according to the present embodiment.

FIG. 6 is a diagram illustrating a process of manufacturing the special SOI substrate to be a base member of the first substrate according to the present embodiment.

First, an Si substrate 71 having a uniform thickness is prepared as illustrated in the first section of FIG. 6. Then, a resist 72 is formed at one surface (second surface 22 side) of the Si substrate 71, and the resist 72 is patterned such that locations other than a location where the BOX layer 2B is formed, to form a resist opening 721 as illustrated in the second section of FIG. 6. The position of the resist opening 721 is a position corresponding to at least the diaphragm unit 25.

In addition, a portion of the Si substrate 71 that is exposed from the resist opening 721 is etched to form a recessed portion pattern 73 as illustrated in the third section of FIG. 6. Etching of the Si substrate 71 may be performed through either dry etching or wet etching. Here, when dry etching is performed, the resist opening 721 is formed so as to be larger than the diaphragm unit 25. That is, a resist pattern is formed such that a region up to the predetermined margin region is opened with the diaphragm unit 25 being the center. When wet etching is performed, the resist opening 721 corresponding to the diaphragm unit 25 is formed, whereby a portion up to the predetermined margin region is etched through side etching with the diaphragm unit 25 being the center.

Then, after the resist 72 is removed as illustrated in the fourth section of FIG. 6, thermal oxidation processing is applied to the front surface of the Si substrate 71 as illustrated in the fifth section of FIG. 4. Through these processes, a SiO₂ layer 74 is formed at the front surface of the Si substrate 71.

After this, the SiO₂ layer 74 side of the Si substrate 71 is cut as illustrated in the sixth section of FIG. 6. At this time, when the recessed portion pattern 73 is formed, the SiO₂ layer is cut so as to be equal to or deeper than a depth at which an Si front surface 71A that is not etched due to the resist 72 is exposed and be less than a depth of the recessed portion pattern 73, in order to expose only the desired BOX layer 2B. Through these processes, of the Si substrate 71, the Si layer that is not thermally oxidized is cut and exposed to form the supporting layer 2A, and the BOX layer 2B is formed by the SiO₂ layer remaining in the recessed portion pattern 73.

Note that, through the thermal oxidation processing described above, the hard mask layer 75 is formed at a surface of the Si substrate 71 that is at the opposite side from the surface where the recessed portion pattern 73 is formed.

After this, an Si layer is formed at the surface of the Si substrate 71 at which the recessed portion pattern 73 is formed, so as to cover the Si front surface 71A (the front surface of the supporting layer 2A) and the SiO₂ layer 74 (BOX layer 2B), as illustrated in the seventh section of FIG. 6. In other words, the active layer 2C including Si is formed so as to cover the supporting layer 2A and the BOX layer 2B. As for formation of the active layer 2C, a target doped with impurities such as boron (B) or phosphorus (P) is used, for example, and a sputtering method is applied to the surface of the Si substrate 71 at which the recessed portion pattern 73 is formed, to form the film.

After these processes, the hard mask layer 75 is cut to form the SOI substrate in which the supporting layer 2A, the BOX layer 2B, and the active layer 2C are stacked.

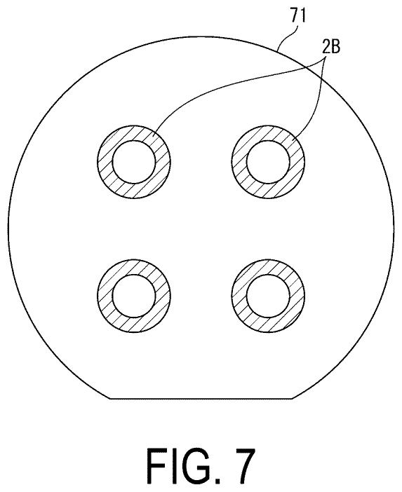

FIG. 7 is a schematic plan view illustrating a portion of the SOI substrate serving as a base member of the first substrate 2, and illustrates the locations of the BOX layer 2B. Portions illustrated with the shading in the drawing indicate the positions where the BOX layer 2B is formed. In other words, in the drawing, the shaded portions indicate a stacked body of the supporting layer 2A, the BOX layer 2B, and the active layer 2C, and portions without shading indicate a stacked body of the supporting layer 2A and the active layer 2C. In the present embodiment, a plurality of first substrates 2 are formed from one base member. Thus, a plurality of annular BOX layers 2B corresponding to the diaphragm units 25 of individual first substrates 2 are formed as illustrated in FIG. 7.

The base member is cut, for example, through laser cutting so as to match the shape (see FIGS. 1 and 2) of the first substrate 2, to form the first substrate 2. Note that, here, description is made of a case, as an example, in which the first substrate 2 is cut out from the base member before the second substrate 3 is bonded to the first substrate 2. However, the cutting process may be performed into the shape of the variable wavelength interference filter 1 after the second substrate 3 is bonded to the first substrate 2.

Next, manufacturing of the variable wavelength interference filter 1 will be described.

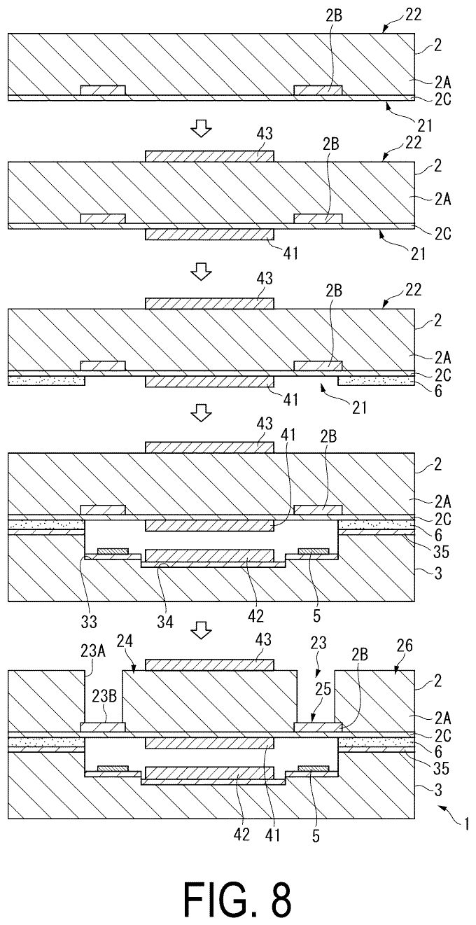

FIG. 8 is a diagram illustrating a method of manufacturing the variable wavelength interference filter 1.

Note that it is assumed that the second substrate 3 is formed in advance, and detailed explanation thereof using FIG. 8 will not be given. The second substrate 3 is formed by cutting the base member of the second substrate 3 so as to have a desired thickness size, and performing etching to the third surface 31 to form the first recessed portion 33, the reflective-film installation section 34, and the terminal section 36. Next, an electrode film is formed at the third surface 31, and the electrode film is patterned through etching or the like to form the drive electrode 5. In addition, the second reflective film 42 is formed at the reflective-film installation section 34. The second reflective film 42 is formed, for example, by forming a lift-off pattern at a portion other than a location where the second reflective film 42 is disposed, then forming a dielectric multilayer film, and removing an unnecessary portion through a lift-off process.

During manufacturing of a variable wavelength interference filter, at the first substrate 2 (the diaphragm unit 25 is not yet formed) including a special SOI substrate as illustrated in the first section of FIG. 8, the first reflective film 41 is formed at a portion of the first surface 21 that corresponds to the movable unit 24 as illustrated in the second section of FIG. 8. In addition, an anti-reflection film 43 may be further formed at a position of the second surface 22 of the first substrate 2 that overlaps with the first reflective film 41 in the Z direction. The first reflective film 41 and the anti-reflection film 43 are formed in a manner similar to the second reflective film 42 described above, and it is possible to use lift-off, for example.

Furthermore, the bonding layer 6 is formed at a portion of the first surface 21 that corresponds to the base section 26 of the first substrate 2 as illustrated in the third section of FIG. 8. Although there is no particular limitation as to the bonding layer 6, it is preferable to use a metal bonding material (for example, a metal in a form of paste such as a silver paste) having electrical conductivity as the bonding layer 6 and expose a portion of this electrically conductive bonding material to the terminal section 36. This makes it possible to easily couple a wiring line such as a lead wire to the electrically conductive bonding material exposed from the terminal section 36. When an electrode in contact with the active layer 2C is separately provided, a material that does not have electrical conductivity may be used as the bonding layer 6, and an example thereof includes a plasma-polymerized layer containing siloxane as the primary component, glass having a low melting point, epoxy resin, or the like, for example.

Next, the first substrate 2 and the second substrate 3 are bonded through the bonding layer 6, as illustrated in the fourth section of FIG. 8.

After this, a dry etching process is performed to the supporting layer 2A of the diaphragm unit 25 of the first substrate 2 with the BOX layer 2B being used as an etching stopper, to form the groove 23, as illustrated in the fifth section of FIG. 8. Here, the BOX layer 2B is formed in a region including the predetermined margin region with the diaphragm unit 25 being the center. Thus, it is possible to suppress a disadvantage in which a portion of the active layer 2C where the BOX layer 2B is not provided is etched through dry etching, whereby it is possible to form the diaphragm unit 25 having a uniform thickness size.

Furthermore, in the present embodiment, the diaphragm unit 25 is formed through dry etching using the BOX layer 2B including the SOI substrate as the etching stopper. This makes the side wall 23A and the bottom surface 25B of the diaphragm unit 25 perpendicular or substantially perpendicular. This makes it possible to suppress the occurrence of side etching as compared with a case where the diaphragm unit 25 is formed through wet etching. Thus, it is possible to reduce the size of the variable wavelength interference filter 1 and increase the diameter of the filter region.

### Operation and Effect of Present Embodiment

The variable wavelength interference filter 1 according to the present embodiment includes the first substrate 2 provided with the first reflective film 41, and the second substrate 3 provided with the second reflective film 42 that is opposed to the first reflective film 41 with the gap G being interposed between the first reflective film 41 and the second reflective film 42. The first substrate 2 includes an SOI substrate in which the supporting layer 2A, the BOX layer 2B, and the active layer 2C are layered in this order along the Z direction, the supporting layer 2A being an Si layer, the BOX layer 2B being a SiO₂ layer, the active layer 2C including Si. The first substrate 2 includes: the movable unit 24 provided with the first reflective film 41; the diaphragm unit 25 configured to surround the movable unit 24 as viewed from the Z direction; and the base section 26 configured to surround the diaphragm unit 25 as viewed from the Z direction and support the movable unit 24 through the diaphragm unit 25 so as to be able to advance and retreat along the Z direction. In addition, the diaphragm unit 25 is a portion having a thickness in the Z direction smaller than the base section 26 due to the groove 23 opening in the second surface 22 of the first substrate 2 that is at an opposite side from the second substrate 3, and includes the BOX layer 2B and the active layer 2C. At least the first surfaces of the base section 26 and the diaphragm unit 25 of the first substrate 2 are flat in a state where the movable unit 24 is not displaced.

The first substrate 2 is a substrate including an SOI substrate as the base member. By providing the BOX layer 2B that is a SiO₂ layer, it is possible to perform dry etching using this BOX layer 2B as an etching stopper. As the groove 23 is formed through dry etching, residual Si of the supporting layer 2A is not generated on the BOX layer 2B. This makes it possible to achieve the diaphragm unit 25 comprised of the BOX layer 2B and the active layer 2C and having a uniform thickness. In addition, unlike a case where wet etching is performed to a single material substrate, side etching does not occur. Thus, it is possible to reduce the size of the variable wavelength interference filter 1. In addition, it is possible to secure the filter region having a large diameter even if the entire size is limited.

In the variable wavelength interference filter 1 according to the present embodiment, the active layer includes Si doped with an impurity.

This configuration makes it possible to impart the active layer 2C with electrical conductivity, and also possible to use this active layer 2C as an electrode. Thus, it is possible to eliminate the need of forming additional metal film or providing a process of patterning this metal film.

In the variable wavelength interference filter 1 according to the present embodiment, the impurity includes B (boron) or P (phosphorus). By doping the Si layer with B or P, it is possible to improve the electrical conductivity, that is, to reduce a resistance when it is used as an electrode.

In the variable wavelength interference filter 1 according to the present embodiment, when the first substrate 2 is viewed from the Z direction, the BOX layer 2B is provided in an annular shape that is closed and surrounds the movable unit 24, and the first surfaces 21 of the movable unit 24, the diaphragm unit 25, and the base section 26 that are disposed at a side opposed to the second substrate 3 are flat when the movable unit 24 is not displaced.

In other words, in the present embodiment, the first surface 21 of the first substrate 2 has a shape surrounded by the active layer 2C. When the active layer 2C is used as an electrode that is opposed to the drive electrode 5 and there is a variation in an initial binary value of the distance between the drive electrode 5 and the active layer 2C, in-plane variation occurs in electrostatic attraction due to application of a voltage, which makes the movable unit 24 tilted. In contrast, in the present embodiment, the distance between the drive electrode 5 and the active layer 2C is uniform. This makes it possible to suppress the tilting of the movable unit 24 when the movable unit 24 is displaced.

### Second Embodiment

The variable wavelength interference filter 1 according to the first embodiment describes an example in which the first substrate 2 includes the special SOI substrate in which the BOX layer 2B is provided up to the predetermined margin region with the diaphragm unit 25 being the center. In contrast, the second embodiment differs from the first embodiment described above in that a normal SOI substrate in which the BOX substrate 2B is formed over the entire substrate is used. Note that, in the following description, the same reference characters are attached to matters that have been already described above, and explanation thereof will not be repeated or will be made in a simplified manner.

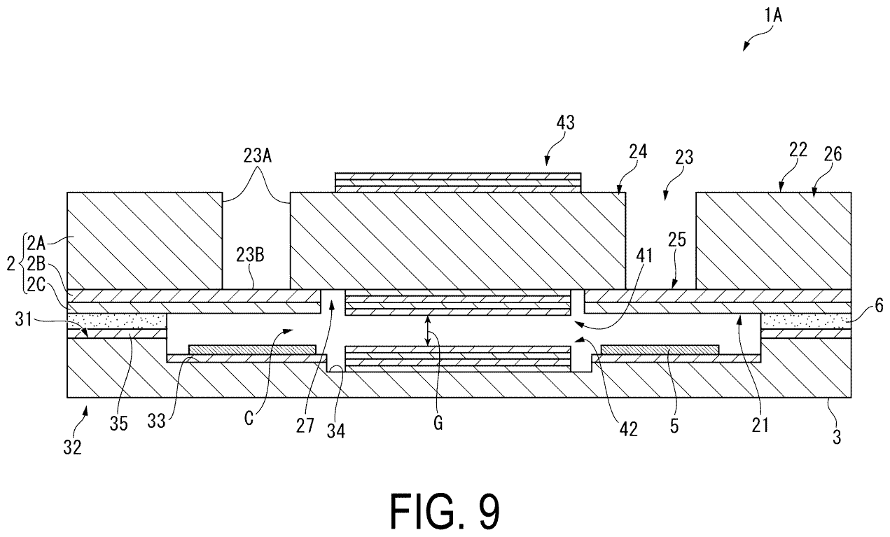

FIG. 9 is a cross-sectional view illustrating the schematic configuration of a variable wavelength interference filter 1A according to the second embodiment. The variable wavelength interference filter 1A according to the present embodiment includes a first substrate 20, the second substrate 3, the first reflective film 41, the second reflective film 42, and the drive electrode 5, as illustrated in FIG. 9. The second substrate 3, the first reflective film 41, the second reflective film 42, and the drive electrode 5 are similar to those in the first embodiment, and hence, explanation thereof will not be repeated.

In the present embodiment, the first substrate 20 uses a normal SOI substrate as the base member as described above. In the base member, the supporting layer 2A, the BOX layer 2B, and the active layer 2C are provided over the entire substrate. In the present embodiment, by processing this base member on an as-necessary basis, the first substrate 20 is configured such that the BOX layer 2B and the active layer 2C are removed at a location where the first reflective film 41 of the movable unit 24 is formed. Thus, an opposing recessed portion 27 (recessed groove according to the present disclosure) that is opposed to the second substrate 3 is provided at the first surface 21 of the movable unit 24. The bottom surface of the opposing recessed portion 27 that is opposed to the second substrate 3 is a portion where the supporting layer 2A is exposed, and the first reflective film 41 is provided at the bottom surface of this opposing recessed portion 27.

In other words, in the present embodiment, the base section 26 includes the supporting layer 2A, the BOX layer 2B, and the active layer 2C, and the diaphragm unit 25 includes a BOX layer and the active layer 2C. The boundary (a portion where the first reflective film 41 is not provided) and its surrounding of the movable unit 24 relative to the diaphragm unit 25 are formed of the supporting layer 2A, the BOX layer 2B, and the active layer 2C. In addition, the central portion of the movable unit 24 where the first reflective film 41 is provided is comprised of the supporting layer 2A.

In such a configuration, a surface portion of the first surface 21 of the first substrate 20 where the opposing recessed portion 27 is not provided is flat when the movable unit 24 is not displaced in the Z direction.

### Method of Manufacturing Variable Wavelength Interference Filter 1A

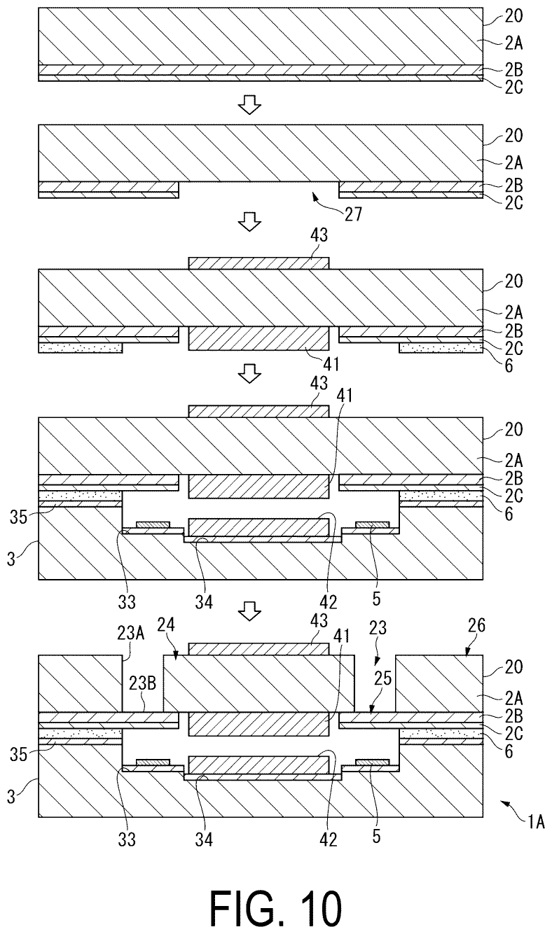

FIG. 10 is a diagram illustrating a method of manufacturing the variable wavelength interference filter 1A according to the present embodiment.

For the variable wavelength interference filter 1A according to the present embodiment, the first substrate 20 (the diaphragm unit 25 is not yet formed) including a normal SOI substrate as illustrated in the first section of FIG. 10 is prepared.

Then, the opposing recessed portion 27 (recessed groove of the present disclosure) is formed at the active layer 2C side of the first substrate 20 so as to match the position where the first reflective film 41 is formed, as illustrated in the second section of FIG. 10.

The opposing recessed portion 27 can be formed, for example, through two-stage etching in which, after the active layer 2C that is an Si layer is etched with HNO₃, the BOX layer 2B that is a SiO₂ layer is etched with HF.

Processes after this are similar to those illustrated in the second section and thereafter of FIG. 8. That is, the first reflective film 41 is formed at the opposing recessed portion 27 as illustrated in the third section of FIG. 10. At this time, the anti-reflection film 43 may be formed at the second surface 22, at an opposite side from the first reflective film 41, of the first substrate 20. In addition, the bonding layer 6 is formed at the base section 26. Then, as illustrated in the fifth section of FIG. 10, the first substrate 20 is bonded through the bonding layer 6 to the second substrate 3 at which the second reflective film 42 and the drive electrode 5 are provided.

After this, dry etching is performed to the second surface 22 of the first substrate 20 using the BOX layer 2B as an etching stopper to form the groove 23, thereby forming the shapes of the movable unit 24, the diaphragm unit 25, and the base section 26. Through these processes, the variable wavelength interference filter 1A is manufactured.

### Operation and Effect of Present Embodiment

In addition to the operation and effects of the variable wavelength interference filter 1 according to the first embodiment described above, the variable wavelength interference filter 1A according to the present embodiment is able to achieve the following effects.

In the present embodiment, the movable unit 24 of the first substrate 20 includes the opposing recessed portion 27 extending through the active layer 2C and the BOX layer 2B and provided at the first surface 21 that is opposed to the second substrate 3. In addition, the supporting layer 2A is exposed at the groove bottom surface of the opposing recessed portion 27. Furthermore, the first reflective film 41 is provided at this groove bottom surface.

In this case, the first substrate 20 can be formed by using a normal SOI substrate as the base member. This makes it possible to reduce the number of manufacturing steps, as compared with a case of using the special SOI substrate.

### MODIFICATION EXAMPLES

Note that the present disclosure is not limited to the embodiments described above, and modifications, improvements, and the like within the scope in which the object of the present disclosure can be achieved are included in the present disclosure.

### First Modification Example

The first embodiment describes an example in which a portion of the bonding layer 6 made of an electrically conductive bonding material is exposed at the terminal section 36 provided at the second substrate 3, and is caused to function as the common electrode terminal 53. However, the configuration is not limited to this. For example, the supporting layer 2A may be comprised of an Si layer doped with impurities such as B or P, as with the active layer 2C. In this case, it is possible to directly couple a wiring line such as a lead line to a portion of the first substrate 2 such as the second surface 22 of the base section 26, for example. In addition, in this case, the bonding layer 6 is not limited to an electrically conductive bonding material. It is possible to use various types of bonding materials such as a plasma-polymerized layer, glass having a low melting point, or epoxy resin.

### Second Modification Example

The second embodiment is configured such that the opposing recessed portion 27 is provided at the normal SOI substrate in which the active layer 2C is formed at the entire substrate, to remove the BOX layer 2B in the filter region, and the multiple reflection is suppressed between the BOX layer 2B and the first reflective film 41. In contrast, it may be possible to use a special SOI substrate as in the first embodiment, that is, use an SOI substrate in which the BOX layer 2B is embedded at a predetermined location.

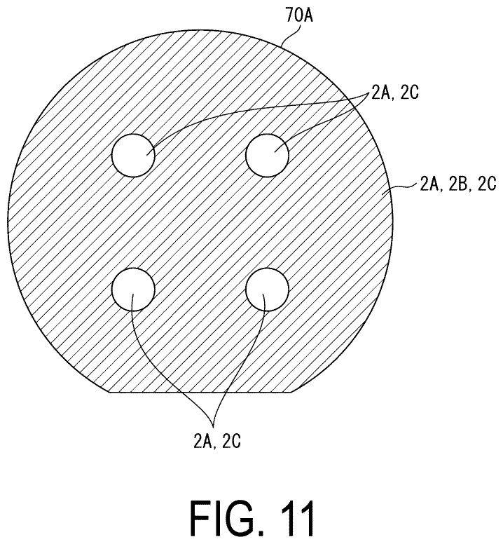

FIG. 11 is a schematic plan view illustrating a first substrate (SOI substrate 70A serving as a base member) before the diaphragm unit 25 according to the second modification example is formed. A shaded portion in the drawing indicates a location where the BOX layer 2B is provided. In other words, in the drawing, the shaded portion indicates a stacked body of the supporting layer 2A, the BOX layer 2B, and the active layer 2C, and portions without shading indicate a stacked body of the supporting layer 2A and the active layer 2C.

In this case, there is no need to use etching to form the opposing recessed portion 27, and it is possible to manufacture a variable wavelength interference filter using the manufacturing method similar to that in the first embodiment. In this configuration, as in the first embodiment, the surface of the first substrate that is opposed to the second substrate 3 is comprised of the active layer 2C of the SOI substrate, and the movable unit 24 is flat in a state where the movable unit 24 is not displaced in the Z direction.

### Third Modification Example

The first embodiment describes an example in which the shape of the BOX layer 2B has an annular shape corresponding to the shape of the diaphragm unit 25 when viewed from the Z direction, and the second embodiment describes an example in which the opposing recessed portion 27 has an annular shape. However, the configuration is not limited to these configurations. There is no particular limitation as to the shape of the BOX layer 2B or the shape of the opposing recessed portion 27 as long as it has a closed annular shape. These elements may be formed into an ellipse shape or a polygonal shape. For example, these elements may be formed into a hexagonal shape along the Si plane direction.

### Overview of Present Disclosure

A variable wavelength interference filter according to one aspect of the present disclosure includes: a first substrate provided with a first reflective film; and a second substrate provided with a second reflective film that is opposed to the first reflective film with a gap being interposed between the first reflective film and the second reflective film, in which the first substrate includes an SOI substrate in which a first layer, a second layer, and a third layer are layered in this order along a thickness direction from the first substrate toward the second substrate, the first substrate including Si, the second layer including SiO₂, the third layer including Si, the first substrate includes: a movable unit provided with the first reflective film; a diaphragm unit configured to surround the movable unit as viewed from the thickness direction from the first substrate toward the second substrate; and a base section configured to surround the diaphragm unit as viewed from the thickness direction and support the movable unit through the diaphragm unit so as to be able to advance and retreat along the thickness direction, the diaphragm unit is a portion having a thickness in the thickness direction smaller than the base section due to a groove opening in a surface of the first substrate that is at an opposite side from the second substrate, and includes the second layer and the third layer, and at least surfaces, at a side of the second substrate, of the base section and the diaphragm unit of the first substrate are flat when the movable unit is not displaced.

In such an aspect, the first substrate is a substrate using a SOI substrate as the base member. Thus, it is possible to apply dry etching to form a groove in the first layer with the second layer being the etching stopper. This makes it possible to configure the diaphragm with the second layer and the third layer, and achieve the diaphragm having a uniform thickness. In addition, unlike a case where wet etching is applied to a substrate including a single material, side etching does not occur. This makes it possible to reduce the size of the variable wavelength interference filter. Furthermore, it is possible to increase the diameter of the area (filter region) that is opposed to the first reflective film and the second reflective film even if the entire size is limited.

In the variable wavelength interference filter of the present aspect, it is preferable that the third layer should include Si doped with an impurity.

This makes it possible to impart the Si layer of the third layer with electrical conductivity. This eliminates the need of forming additional electrode on the substrate, and makes it possible to simplify the configuration and also possible to simplify the manufacturing process when the variable wavelength interference filter is manufactured.

In the variable wavelength interference filter of the present aspect, it is preferable that the impurity should be boron or phosphorus.

This makes it possible to impart the Si layer of the third layer with high electrical conductivity, which makes it possible to cause the layer to more favorably function as an electrode.

In the variable wavelength interference filter of the present aspect, it is preferable to employ a configuration in which a front surface of the movable unit that is opposed to the second substrate is provided with a recessed groove extending through the second layer and the third layer in the thickness direction, a groove bottom surface of this recessed groove serves as a front surface of the first layer, and the first reflective film is provided at the groove bottom surface. With this configuration, the second layer that is the SiO₂ layer is not provided at a location where the first reflective film is provided. This prevents multiple reflection at the first reflective film and the second layer. Thus, it is possible to favorably output light having a desired wavelength from the variable wavelength interference filter.

In the variable wavelength interference filter of the present aspect, when the first substrate is viewed from the thickness direction, the second layer is provided in an annular shape that is closed and surrounds the movable unit, and surfaces, at a side opposite to the second surface, of the movable unit, the diaphragm unit, and the base section are flat when the movable unit is not displaced.

In the present aspect, the second layer is not provided at a portion where the first reflective film is provided. Thus, similarly to the aspect described above, there is no multiple reflection between the first reflective film and the second layer, and it is possible to favorably output light having a desired wavelength from the variable wavelength interference filter. In addition, the surfaces, at a side opposed to the second substrate, of the diaphragm unit and the base section are flat. Thus, when the third layer of the diaphragm unit is caused to function as an electrode, the distance between the third layer and the drive electrode provided at the second substrate can be made uniform. This makes it possible to suppress the tilting of the movable unit when the movable unit is displaced.

The variable wavelength interference filter of the present aspect may be configured such that, when the first substrate is viewed from the thickness direction, the second layer is not provided at the movable unit, and is provided at the diaphragm unit and the base section, and surfaces, at a side opposite to the second surface, of the movable unit, the diaphragm unit, and the base section are flat when the movable unit is not displaced.

In the present aspect, the second layer is also not provided at a portion where the first reflective film is provided. Thus, similarly to the aspect described above, there is no multiple reflection between the first reflective film and the second layer, and it is possible to favorably output light having a desired wavelength from the variable wavelength interference filter. In addition, the surfaces, at a side opposed to the second substrate, of the diaphragm unit and the base section are flat. Thus, when the third layer of the diaphragm unit is caused to function as an electrode, the distance between the third layer and the drive electrode provided at the second substrate can be made uniform. This makes it possible to suppress the tilting of the movable unit when the movable unit is displaced.

What is claimed is:

1. A variable wavelength interference filter comprising:
a first substrate provided with a first reflective film; and
a second substrate provided with a second reflective film that is opposed to the first reflective film with a gap being interposed between the first reflective film and the second reflective film, wherein
the first substrate includes an SOI substrate in which a first layer, a second layer, and a third layer are layered in this order along a thickness direction from the first substrate toward the second substrate, the first substrate including Si, the second layer including SiO₂, the third layer including Si,
the first substrate includes:
a movable unit provided with the first reflective film;
a diaphragm unit configured to surround the movable unit as viewed from the thickness direction from the first substrate toward the second substrate; and
a base section configured to surround the diaphragm unit as viewed from the thickness direction and support the movable unit through the diaphragm unit so as to be able to advance and retreat along the thickness direction,
the diaphragm unit is a portion having a thickness in the thickness direction smaller than the base section due to a groove opening in a surface of the first substrate that is at an opposite side from the second substrate, and includes the second layer and the third layer, and
at least surfaces, at a side of the second substrate, of the base section and the diaphragm unit of the first substrate are flat when the movable unit is not displaced.

2. The variable wavelength interference filter according to claim 1, wherein the third layer includes Si doped with an impurity.

3. The variable wavelength interference filter according to claim 2, wherein the impurity is boron or phosphorus.

4. The variable wavelength interference filter according to claim 1, wherein
a front surface of the movable unit that is opposed to the second substrate is provided with a recessed groove extending through the second layer and the third layer in the thickness direction,
a groove bottom surface of this recessed groove serves as a front surface of the first layer, and
the first reflective film is provided at the groove bottom surface.

5. The variable wavelength interference filter according to claim 1, wherein,
when the first substrate is viewed from the thickness direction, the second layer is provided in an annular shape that is closed and surrounds the movable unit, and
surfaces, at a side opposed to the second substrate, of the movable unit, the diaphragm unit, and the base section are flat when the movable unit is not displaced.

6. The variable wavelength interference filter according to claim 1, wherein
when the first substrate is viewed from the thickness direction, the second layer is not provided at the movable unit, and is provided at the diaphragm unit and the base section, and
surfaces, at a side opposed to the second substrate, of the movable unit, the diaphragm unit, and the base section are flat when the movable unit is not displaced.
